(19) United States
(12) Patent Application Publication
(10) Pub. No.: US 2012/0285755 A1
(43) Pub. Date: Nov. 15, 2012

(54) SINGLE SPEED TRANSMISSION FOR ELECTRIC VEHICLE WITH MECHANICAL OR ELECTRICAL PARK SYSTEM

(75) Inventor: Robert F. KELLER, Chesterfield, MI (US)

(73) Assignee: BorgWarner Inc., Auburn Hills, MI (US)

(21) Appl. No.: 13/450,810

(22) Filed: Apr. 19, 2012

Related U.S. Application Data
(60) Provisional application No. 61/484,374, filed on May 10, 2011.

(51) Int. Cl. F16H 63/34; B60K 1/00; B60T 1/06; B60K 17/00

(52) U.S. Cl. 180/65.1; 192/219.6; 192/219.5

(57) ABSTRACT

A power transfer system (60) for a vehicle to be driven by a prime mover, such as an electric motor, through an input drive shaft (12) carried by the vehicle to be interconnected to an output drive shaft (18) for driving driven wheels of the vehicle. A single speed transmission (68) for an electric motor (62) of a driven vehicle (14) defined by a first drive sprocket (22) connected to an input drive shaft (12) to be driven by an electric motor (62), and a second drive sprocket (24) connected to an output drive shaft (18) for driving driven wheels of the electric motor driven vehicle (14), and an endless flexible loop power transferring member (26) extending between the first and second sprockets (22, 24). A parking brake mechanism (10) for engaging and disengaging with respect to the output drive shaft (18) to prevent rotation of the output drive shaft (18) when engaged by a vehicle operator through mechanical or electrical drive mechanisms (16, 16a).

### FIELD OF THE INVENTION

The invention relates to a transmission that receives rotary input torque from a power source and transmits the torque to an output load, combined with a brake to retard or stop rotation of the output load, and more particularly, to an automobile or other mechanism for transporting passengers or cargo where the power source includes an electric motor to propel the mechanism, and where the brake retards or stops movement of the transmission of the vehicle and is influenced by a controller of the transmission for transmitting torque, including structure to hold the brake in an engaged condition even if the vehicle is unattended, where the brake includes a pivoting projection that engages a toothed wheel.

### BACKGROUND

Parking brake assemblies are used in automotive vehicles to operatively engage the parking gear of a vehicle, thereby maintaining the vehicle in a parked position or state. Parking brake assemblies typically include a rotatable member or a parking pawl, which is selectively engaged by the actuator of the vehicle when the transmission of the vehicle is shifted into the parked position. When the actuator engages the parking pawl, the parking pawl pivots or rotates into a position to locate a portion of the parking pawl between a pair of teeth on the parking gear to substantially prevent further rotation of the parking gear and the output shaft. A return spring is typically connected to the parking pawl and causes the parking pawl to disengage from the parking gear when the actuator is retracted, i.e., when the vehicle is shifted out of the parked position. Parking brakes for automatic transmissions are generally known in the art. For example, see U.S. Pat. Nos. 2,974,752; 4,223,768; 4,576,261; 4,667,783; 4,671,133; 4,722,427; 5,685,406; 5,807,205; 5,934,436; 6,065,581; 6,290,047; and 7,556,135. While each of these devices is generally suitable to perform the intended function, it would be desirable to provide a parking brake for a single speed transmission for an electric vehicle.

### SUMMARY

A power transfer system can support an input drive shaft to be mechanically interconnected to an output drive shaft for driving driven wheels of an electric motor vehicle. An input drive sprocket can be connected to the input drive shaft and an output drive sprocket can be connected to the output drive shaft. An endless loop sprocket-engaging drive member can extend between the input drive sprocket and the output drive sprocket to define a single speed transmission. It would be desirable to provide a parking brake system for the power transfer system of the electric motor vehicle. The parking brake system can be a mechanically actuated system or an electrically actuated system. The parking brake system can include a parking pawl and a parking gear to be assembled into a parking brake assembly for the single speed transmission of the electric motor vehicle.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a schematic diagram of a power transfer system having a power input, a power output, a chain and sprocket connection between the power input and the power output, and a parking brake mechanism associated with the power output and the sprocket, where the parking brake system is connected to the cover side of the assembly,

FIG. 2 is an alternative schematic diagram of a power transfer system having a power input, a power output, a chain and sprocket connection between the power input and the power output, and a parking brake mechanism associated with the power output and the sprocket, where the parking brake system is connected to the case side of the assembly,

FIG. 3A is a simplified schematic diagram of a mechanically actuated parking brake system in a disengaged position; and

FIG. 3B is a simplified schematic diagram of an electrically actuated parking brake system in an engaged position.

### DETAILED DESCRIPTION

As used herein an engine or prime mover is defined as a primary source of rotational energy. As used herein an input shaft is defined as a mechanism that receives rotational motion from an engine and transfers such motion to a gear transmission or to a clutch. As used herein a gear transmission is defined as a mechanism including at least one gearing power path. The mechanism being capable of changing a speed ratio or rotational direction between a mechanical output of an engine and a load. As used herein a speed ratio is defined as a rotational velocity of an output shaft divided by the rotational velocity of an input shaft. As used herein a load is defined as a mechanism that receives rotational motion from a gear transmission or clutch to do useful work. As used herein a clutch is defined as a mechanism operable to couple two relatively rotatable parts together for common rotation or to uncouple such parts. The clutch as used in the definition is a clutch that may be used without a gear transmission or in advance of or behind a gear transmission in a power train. As used herein a gearing power path or power transfer system is defined as a mechanism including relatively rotatable bodies having engaging surfaces or which are drivingly connected by a belt or chain whereby a rotatable body will impart to or receive rotary motion or power from another rotary body by rolling contact. As used herein an output shaft is defined as a mechanism that receives rotational motion from a gear transmission or clutch and transfers such motion to a load. As used herein a chain or belt is defined as a power transferring member forming an endless loop and constructed of flexible material, or of articulated rigid links, to permit the member to conform to a radius of curvature of a sprocket or pulley drive face and intended, in use, to be driven in an endless path; and, by contact with the sprocket or pulley drive face, to transmit power to or extract power from the sprocket or pulley. As used herein a sprocket or pulley is defined as a device rotatable about an axis and having a drive face radially spaced from the axis of rotation for intended power transferring engagement with a chain or belt to drive the chain or belt on its endless path or to extract power from the chain or belt to drive an output load device.

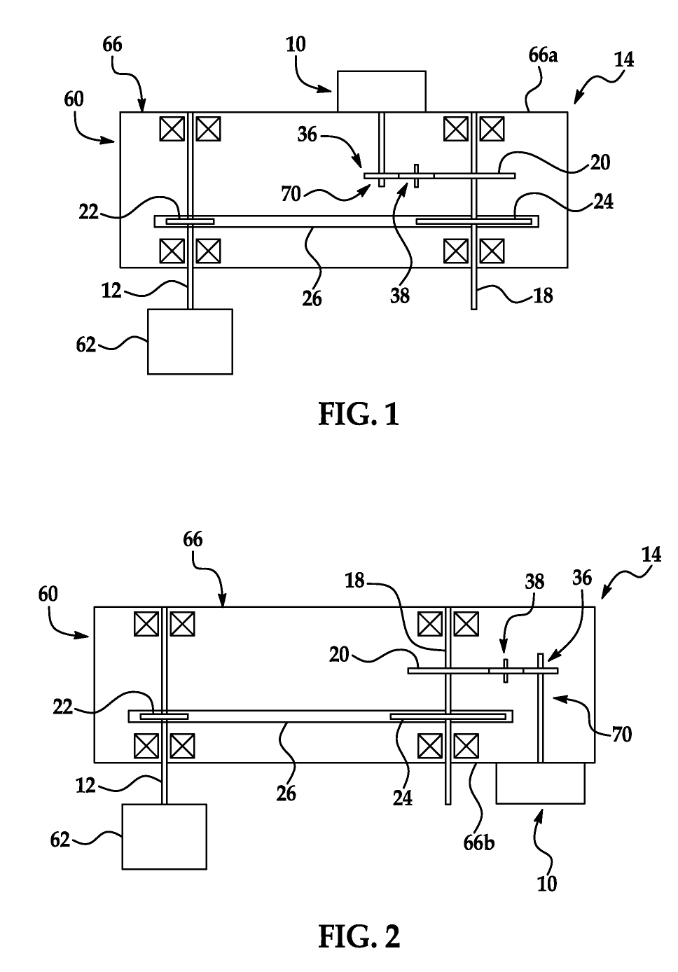

Referring now to FIGS. 1-2, a transmission, or gearing power path, or a power transfer system 60 for a land vehicle is schematically illustrated being powered by an electric motor engine or prime mover carried on the vehicle. The prime mover drives the 2 5 vehicle through an input drive shaft 12 with the electric motor 62 for driving the vehicle through an output drive shaft 18. The electric motor 62 of the electric motor driven vehicle 14 is mechanically interconnected through the gearing power path with the drive wheels for driving the vehicle 14. The gearing power path or power transfer system 60 includes relatively rotatable first and second drive sprocket bodies 22, 24 provided with teeth and an endless flexible loop power transferring member 26 having teeth-engaging elements, whereby a rotatable sprocket body 24 will transfer power to or from another sprocket body 22 by contact with the endless flexible loop power transferring member 26. The transmission or power transfer system 60 connects a power source, such as electric motor 62, to the output load. The power transfer system 60 includes a rotatable power input sprocket body 22 in driving engagement with the endless flexible loop power transferring member 26 for advancing the endless flexible loop power transferring member along an endless path of travel. A rotatable power output sprocket body 24 engages with the endless flexible loop power transferring member 26 at a position along such endless path to be driven by the endless flexible loop power transferring member 26, by way of example and not limitation, such as via teeth-engaging surfaces or elements, and supply power for driving a load. Each sprocket body 22, 24 structure includes a drive face formed by circumferentially spaced, radially extending teeth intended for driving engagement with radially extending teeth-engaging surfaces correspondingly spaced along the length of the endless flexible loop power transferring member 26.

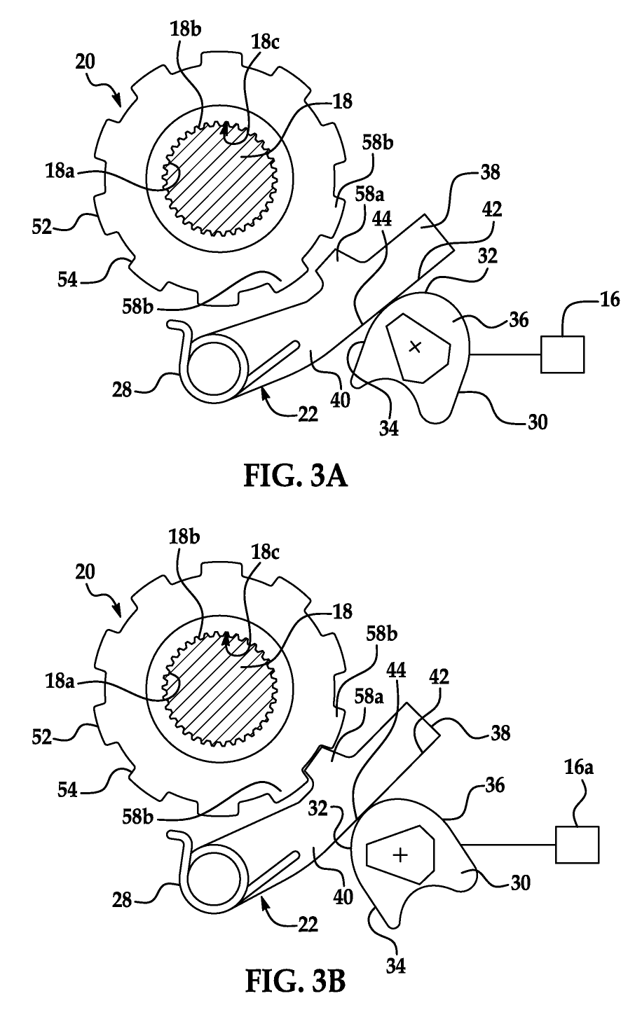

Referring now to FIGS. 1-3B, a parking brake 10 is shown in simplified schematic view including a toothed parking gear 20 having an axis of rotation and an output load shaft receiving aperture 18a for connection to the output load or output drive shaft 18 (shown in FIG. 1), a pivotable parking pawl 38, a cam actuator 36 moveable between a disengaged position and an engaged position, and a spring 28 for biasing the parking pawl 38 toward the disengaged position. The parking pawl 38 is engageable with the toothed parking gear 20 for stopping rotational motion of the output load shaft 18 when in an engaged position (best seen in FIG. 3B), even if the vehicle 14 is unattended. The parking pawl 38 is rotatable with respect to a pivot axis in response to movement of the cam actuator 36 between the first position (best seen in FIG. 3B) and the second position (best seen in FIG. 3A). The parking pawl 38 is pivotable between a disengaged position spaced from the toothed parking gear 20 (best seen in FIG. 3A) and the engaged position contacting the toothed parking gear 20 (best seen in FIG. 3B). The pivot axis of the parking pawl 38 can be parallel to and offset from the axis of rotation of the toothed parking gear 20. The body 30 of the cam actuator 36 is rigid and has at least one peripherally extending cam surface 32 defining a load-bearing surface 34. The body 40 of the parking pawl 38 is rigid and has a peripherally extending cam follower surface 42. The peripherally extending cam follower surface 42 of the body 40 defines at least one load-bearing surface 44. The toothed parking gear 20 is rigid and has a peripherally extending surface 52. The peripherally extending surface 52 defines a load-bearing surface 54.

In operation, the toothed parking gear 20 is fixedly connected non-rotationally with respect to the output load shaft 18, such as through complementary splines 18b formed at the interface 18c between the gear 20 and shaft 18. The parking pawl 38 is normally held in a disengaged position by spring 28 until acted on by cam actuator 36. The cam actuator 36 is moveable between a disengaged position, and an engaged position. As the cam actuator 36 moves between the disengaged and engaged positions, load-bearing surfaces 34, 44 of the cam actuator 36 and parking pawl 38 respectively are engaged with the cam actuator 36 driving the parking pawl 38 in rotation between the disengaged position and the engaged position with respect to the toothed parking gear 20. When in the engaged position, a tooth 58a (best seen in FIGS. 3A, 3B) of the parking pawl 38 engages between adjacent teeth 58b (best seen in FIGS. 3A, 3B) of the toothed parking gear 20. The cam actuator 36 engages the parking pawl 38 to maintain the parking pawl 38 in the engaged position working against the urging of spring 28. The interaction of tooth 58a of the parking pawl 38 in the engaged position with the adjacent teeth 58b of the toothed parking gear 20 prevents rotation of the output load shaft 18, even if the vehicle is unattended. When the cam actuator 36 is moved from the engaged position to the disengaged position, the spring 28 urges the parking pawl 38 toward the disengaged position moving the tooth 58a of the parking pawl 38 to a position spaced from the teeth 58b of the toothed parking gear 20 allowing the output load shaft 18 to freely rotate.

The cam actuator 36 can be connected to a mechanical drive mechanism 16, by way of example and not limitation, such as a shift, cable and switch combination, schematically illustrated in FIG. 3A. Alternatively, the cam actuator 36 can be connected to an electrical drive mechanism 16a, by way of example and not limitation, such as an electrical drive motor, schematically illustrated in FIG. 3B. In either case, the cam actuator 36 is driven in movement about an axis of rotation through at least an angular arc between the disengaged and engaged positions by the mechanical drive mechanism 16 or electric drive motor 16a, whereby the parking brake 10 when in the engaged position stops rotation of the output load and prevents movement of the vehicle 14, even if unattended. The combination of the mechanical drive mechanism 16 or electrical drive motor 16a, the toothed parking gear 20, parking pawl 38, and cam actuator 36 define a parking brake mechanism 70.

In operation, as illustrated in FIGS. 1 and 2, the power transfer system 60 transfers power from the electric motor 62 through the input drive shaft 12, sprockets 22, 24 and flexible loop power transferring member 26 to the output drive shaft 18 to drive the driven wheel load of the motorized vehicle 14 for transporting at least one of passenger and cargo, wherein the parking brake 10 is capable of stopping rotation of the output load and prevents movement of the vehicle 14, even if unattended. FIG. 1 illustrates that the drive box 66 with the mechanical or electrical parking brake system 10 attached to the cover side 66a of the assembly. FIG. 2 shows the drive box 66 with the mechanical or electrical parking brake system 10 attached to the case side 66b of the assembly.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A power transfer system (60) for supporting an input drive shaft (12) to be mechanically interconnected to an output drive shaft (18) for driving driven wheels of an electric motor driven vehicle (14) comprising:
a single speed transmission (68) for an electric motor driven vehicle (14) defined by a first drive sprocket (22) connected to an input drive shaft (12) to be driven by an electric motor (62), a second drive sprocket (24) connected to an output drive shaft (18) for driving driven wheels of the electric motor driven vehicle (14), and an endless flexible loop power transferring member (26) extending between the first and second sprockets (22, 24); and
a parking brake mechanism (10) for engaging and disengaging with respect to the output drive shaft (18) to prevent rotation of the output drive shaft (18) when engaged by a vehicle operator.

2. The power transferring system (60) of claim 1, wherein the parking brake mechanism (10) further comprises:
a parking gear (20) connected to the output drive shaft (18); and
a parking pawl (38) rotatable between a disengaged position spaced from the parking gear (20) and an engaged position contacting the parking gear (20).

3. The power transferring system of claim 2, wherein the parking brake mechanism (10) further comprises:
a cam actuator (36) engageable with the parking pawl (38) and rotatable through at least an angular arc between a first position corresponding to the disengaged position of the parking pawl (38) and a second position corresponding to the engaged position of the parking pawl (38).

4. The power transferring system of claim 3, wherein the parking brake mechanism (10) further comprises:
a mechanical drive mechanism (16) for driving the cam actuator (36) between the first and second positions.

5. The power transferring system of claim 3, wherein the parking brake mechanism further comprises:
an electrical drive motor (16a) for driving the cam actuator (36) between the first and second positions.

6. In a parking brake assembly (10) for a transmission (60) of a motorized vehicle (14) for transporting at least one of passenger and cargo, where the transmission (60) receives rotary input torque from a power source (62) and transmits the rotary input torque to an output load to propel the vehicle (14), wherein the parking brake assembly (10) stops rotation of the output load and prevents movement of the vehicle (14), the improvement comprising:
a single speed transmission (68) for an electric motor driven vehicle (14) defined by a first drive sprocket (22) connected to an input drive shaft (12) to be driven by an electric motor (62), a second drive sprocket (24) connected to an output drive shaft (18) for driving driven wheels of the electric motor driven vehicle (14), and an endless flexible loop power transferring member (26) extending between the first and second sprockets (22, 24); and
a parking brake mechanism (70) for engaging and disengaging with respect to the output drive shaft (18) to prevent rotation of the output drive shaft (18) when engaged by a vehicle operator.

7. The improvement of claim 6, wherein the parking brake mechanism (70) further comprises:
a toothed parking gear (20) connected to the output load and having an axis of rotation; and
a pivotable parking pawl (38) engageable with the toothed parking gear (20) for stopping rotational motion of the output load in an engaged position even if the vehicle (14) is unattended, the parking pawl (38) pivotable between a disengaged position spaced from the toothed parking gear (20) and the engaged position contacting the toothed parking gear (20).

8. The improvement of claim 7, wherein the parking brake mechanism (70) further comprises:
a cam actuator (36) movable between a first position and a second position, the pivotable parking pawl (38) rotatable with respect to a pivot axis in response to movement of the cam actuator (36) between the first position and the second position.

9. The improvement of claim 8, wherein the parking brake mechanism (70) further comprises:
a mechanical drive mechanism (16) for driving the cam actuator (36) between the first and second positions.

10. The improvement of claim 8, wherein the parking brake mechanism (70) further comprises:
an electrical drive motor (16) for driving the cam actuator (36) between the first and second positions.

11. In a power transfer system (60) for a land vehicle (14) by an electric motor (62) carried on the vehicle, wherein the electric motor (62) drives the vehicle (14) through an input drive shaft (12), wherein the electric motor (62) is mechanically interconnected with drive wheels for driving the vehicle (14), the power transfer system (60) including relatively rotatable sprocket bodies (22, 24) provided with teeth and an endless flexible loop power transferring member (26) having teeth-engaging elements, whereby a rotatable sprocket body (24) transfers power from another sprocket body (22) by contact with teeth-engaging elements of the endless flexible loop power transferring member (26), wherein the power transfer system (60) connects the electric motor (62) to an output load, wherein the power transfer system (60) includes a rotatable power input sprocket body (22) in driving engagement with the endless flexible loop power transferring member (26) for advancing the endless flexible loop power transferring member (26) along an endless path of travel, and wherein a rotatable power output sprocket body (24) engages with the endless flexible loop power transferring member (26) at a position along such endless path to be driven by the endless flexible loop power transferring member (26) and supply power for driving a load, wherein each sprocket body (22, 24) structure includes a drive face formed by circumferentially spaced, radially extending teeth intended for driving engagement with radially extending teeth-engaging surfaces correspondingly spaced along a length of the endless flexible loop power transferring member (26), the improvement of the power transfer system (60) comprising:
a single speed transmission (68) for an electric motor driven vehicle (14) defined by a first drive sprocket (22) connected to an input drive shaft (12) to be driven by an electric motor (62), a second drive sprocket (24) connected to an output drive shaft (18) for driving driven wheels of the electric motor driven vehicle (14), and an endless flexible loop power transferring member (26) extending between the first and second sprockets (22, 24); and
a parking brake mechanism (70) for engaging and disengaging with respect to the output drive shaft (18) to prevent rotation of the output drive shaft (18) when engaged by a vehicle operator.

12. The improvement of claim 11, wherein the parking brake mechanism (70) further comprises:
a toothed parking gear (20) connected to the output load and having an axis of rotation; and
a pivotable parking pawl (38) engageable with the toothed parking gear (20) for stopping rotational motion of the output load in an engaged position even if the vehicle is unattended, the parking pawl (38) pivotable between a disengaged position spaced from the toothed parking gear (20) and an engaged position contacting the toothed parking gear (20).

13. The improvement of claim 12, wherein the parking brake mechanism (70) further comprises:
a cam actuator (36) movable between a first position and a second position, the pivotable parking pawl (38) rotatable with respect to a pivot axis in response to movement of the cam actuator (36) between the first position and the second position.

14. The improvement of claim 13, wherein the parking brake mechanism (70) further comprises:
a mechanical drive mechanism (16) for driving the cam actuator (36) between the first and second positions.

15. The improvement of claim 13, wherein the parking brake mechanism (70) further comprises:
an electrical drive motor (16a) for driving the cam actuator (36) between the first and second positions.
